(19) United States
(12) Patent Application Publication
(10) Pub. No.: US 2016/0142778 A1
(43) Pub. Date: May 19, 2016

(54) NETWORK CAMERA, NETWORK CAMERA CONTROL TERMINAL, AND VIDEO RECORDING/DELIVERING SYSTEM

(71) Applicant: HITACHI INDUSTRY & CONTROL SOLUTIONS, LTD., Hitachi-shi, Ibaraki (JP)

(72) Inventors: Hirotaka MORIBE, Tokyo (JP); Masuo OKU, Tokyo (JP)

(21) Appl. No.: 14/899,224

(22) PCT Filed: Jun. 28, 2013
(86) PCT No.: PCT/JP2013/067761

§ 371 Date: Dec. 17, 2015

(51) Int. Cl. H04N 21/472; H04N 21/435; H04N 21/2343; H04N 21/2662; H04N 21/643; H04N 21/4223

(52) U.S. Cl. CPC H04N 21/47202; H04N 21/643; H04N 21/4223; H04N 21/234363; H04N 21/2662; H04N 21/4356

(57) ABSTRACT

One of the constituent devices of a video recording/delivering system can be replaced with a generic IT device, without impairing functions which are implemented by the entire video recording/delivering system by using a dedicated protocol specialized for the video recording/delivering system among the devices which constitute the video recording/delivering system, thereby reducing the cost of the video recording/delivering system. Each network camera receives a video data delivery request, which is transmitted from a network camera control terminal by using a dedicated protocol specialized for a video recording/delivering system, by using the dedicated protocol specialized for the video recording/delivering system and delivers, in response to the video data delivery request, currently captured live video data, or video data which are obtained from a storage device by using a general-purpose protocol, to the network camera control terminal by using the dedicated protocol specialized for the video recording/delivering system.

### TECHNICAL FIELD

The present invention relates to a video recording/delivering system and a network camera and a network camera control terminal configuring the same.

### BACKGROUND ART

There is a video recording/delivering system including a network-connectable network camera capable of transmitting a captured video via a network, a recorder terminal capable of receiving a video captured by the network camera via the network and recording and storing the video, and a network control terminal capable of receiving the video captured by the network camera via the network and displaying the video.

The network-connectable network camera and the recorder terminal configuring the video recording/delivering system have a function of setting various functions provided by the network camera and the recorder terminal and a function of transmitting and receiving video data, which are triggered from the network camera control terminal at a remote site via the network.

Commonly, control of the functions is performed between two of the network camera and, the recorder terminal, and the network camera control terminal configuring the video recording/delivering system according to a dedicated communication protocol specific to the video recording/delivering system using the communication protocol (for example, Non Patent Literature 1).

Thus, it is necessary for companies that manufacture these devices to conduct, for example, development for equipping each of the network camera, the recorder terminal, and the network camera control terminal configuring the video recording/delivering system with a function of processing the dedicated protocol specific to the video recording/delivering system. For this reason, the devices configuring the video recording/delivering system tend to be higher in cost than when an IT device having a common general-purpose protocol that has been widespread is used.

Thus, if any one of the network camera, the recorder terminal, and the network camera control terminal configuring the video recording/delivering system can be replaced with the IT device having the common general-purpose protocol, there is a possibility that the cost of the video recording/delivering system will be reduced.

In this case, for example, the video recording/delivering system is considered to be configured such that the recorder terminal having the dedicated protocol specific to the video recording/delivering system is replaced with a network-connectable storage device in which reading and writing of data can be performed using a common general-purpose protocol, and video data delivered by the network camera is stored in the storage device.

As a technique of implementing the configuration of the video recording/delivering system using the storage device capable of reading and writing video data delivered from the network camera using the common general-purpose protocol, for example, a method in which a network camera control terminal designates a type of a storage that records video data of a network camera, is connected to a storage with which the network camera is equipped or a storage device capable of recording data via a network, and records and stores video data of the network camera has been proposed in Patent Literature 1.

### CITATION LIST

### Patent Literature

Patent Literature 1: JP 2013-5453 A

### Non Patent Literature

Non Patent Literature 1: ONVIF, “ONVIF Profile S Specification Ver.1.0,” ONVIF, December, 2011

### SUMMARY OF THE INVENTION

### Problems to be Solved by the Invention

However, in the method disclosed in Patent Literature 1, when the video data of the network camera is recorded and stored in a common storage device, although the network camera control terminal desires to refer to the video data recorded and stored in the storage device, the storage device does not support the dedicated protocol specific to the video recording/delivering system, and thus it is difficult to directly refer to desired video data from the storage device through a process according to the dedicated protocol that has been arranged in the network camera control terminal from the past and is specific to the video recording/delivering system, and it is difficult to refer to video data using software supporting the dedicated protocol that is arranged in the network camera control terminal and specific to the video recording/delivering system.

Further, when the video data of the network camera is recorded and stored in the storage with which the network camera is equipped, although the network camera control terminal desires to refer to the video data recorded and stored in the storage of the network camera, even when the network camera supports the dedicated protocol specific to the video recording/delivering system, and thus it is possible to directly refer to desired video data from the network camera through the process according to the dedicated protocol that has been arranged in the network camera control terminal from the past and is specific to the video recording/delivering system, there are cases in which it is difficult to refer to the video data according to an operation state of the network camera at each point in time due to restriction in performance or resources of the network camera.

For example, when the network camera operates to record and store the video data in the storage with which the network camera is equipped while delivering a live video being currently projected from a lens to the network camera control terminal at a high resolution, if the network camera control terminal makes a delivery request for desired video data recorded in the storage of the network camera, a delivery operation may not be performed as expected due to restriction in performance of a memory, various kinds of I/Os, or a central processing unit (CPU) of the network camera or the like or restriction in resources based on, for example, a maximum number in which a video encoder or the like can simultaneously perform an encoding process on moving image data at a certain resolution, and it is difficult to normally refer to the video data in the network camera control terminal. As described above, the network camera is often lower in simultaneous processing capability than a common general-purpose computer or the like.

The present invention was made in light of the foregoing, and it is an object of the present invention to provide a video recording/delivering system and a network camera and a network camera control terminal configuring the same, which are capable of performs setting of various kinds of functions or transmission and reception of video data using the dedicated protocol that has been arranged from the past and is specific to the video recording/delivering system without damaging performance related to various kinds of functions provided by a single recorder terminal and video data delivery even when a device that records and stores video data such as the recorder terminal configuring the video recording/delivering system is replaced with an IT device having a common general-purpose protocol such as a network attached storage (NAS) device.

### Solutions to Problems

A representative example of the present invention is as follows. In other words, the present invention provides a video recording/delivering system including a plurality of network cameras, a data recording device, and a network camera control terminal which are connected to a network.

Each of the network cameras receives a delivery request for video data transmitted from the network camera control terminal using a first protocol via the network using the first protocol, and delivers live video data that is being currently projected and temporarily recorded in the storage unit or video data that is acquired from the data recording device using a second protocol and temporarily recorded in the storage unit to the network camera control terminal via the network using the first protocol in response to the delivery request for the video data.

The network camera control terminal transmits a delivery request for the video data to each of the network cameras via the network using the first protocol, receives the video data requested by the delivery request using the first protocol from each of the network cameras via the network using the first protocol, and causes the received video data to be displayed on a display unit.

### Effects of the Invention

According to the video recording/delivering system of the present invention, it is possible to replace some devices configuring a video recording/delivering system with a common IT device having no function of executing a dedicated protocol specific to the video recording/delivering system without damaging a function implemented by the entire video recording/delivering system using the dedicated protocol specific to the video recording/delivering system between devices configuring the video recording/delivering system, and thus it is possible to reduce the cost of the video recording/delivering system.

### BRIEF DESCRIPTION OF THE DRAWINGS

FIG. 1 is a diagram illustrating a configuration of a video recording/delivering system 1 according to an embodiment of the present invention.

FIG. 2 is a diagram illustrating a hardware configuration of a network camera 3 according to an embodiment of the present invention.

FIG. 3 is a diagram illustrating a hardware configuration of a network camera control terminal 5 according to an embodiment of the present invention.

FIG. 4 is a functional block diagram illustrating a network camera 3 according to an embodiment of the present invention.

FIG. 5 is a diagram illustrating a file in which data stored in a NAS device 4 is described according to an embodiment of the present invention.

FIG. 6 is a diagram illustrating a content list recorded in a file stored in a NAS device 4 according to an embodiment of the present invention.

FIG. 7 is a functional block diagram illustrating a network camera control terminal 5 according to an embodiment of the present invention.

FIG. 8 is a diagram illustrating a video display format on a screen of a monitor 36 of a network camera control terminal 5 according to an embodiment of the present invention.

FIG. 9 is a flowchart illustrating the flow of a network camera process of a network camera 3 according to an embodiment of the present invention.

FIG. 10 is a flowchart illustrating the flow of a network camera control terminal process of a network camera control terminal 5 according to an embodiment of the present invention.

FIG. 11 is an interaction diagram illustrating the flow of communication and a process performed between a network camera 3 and a network camera control terminal 5 when connected to a NAS device 4 in a video recording/delivering system 1 according to an embodiment of the present invention.

FIG. 12 is an interaction diagram illustrating the flow of communication and a process performed between a network camera 3 and a network camera control terminal 5 when connected to a NAS device 4 in a video recording/delivering system 1 according to an embodiment of the present invention.

### DESCRIPTION OF EMBODIMENTS

Hereinafter, a video recording/delivering system 1 according to an embodiment of the present invention will be described.

(System Configuration)

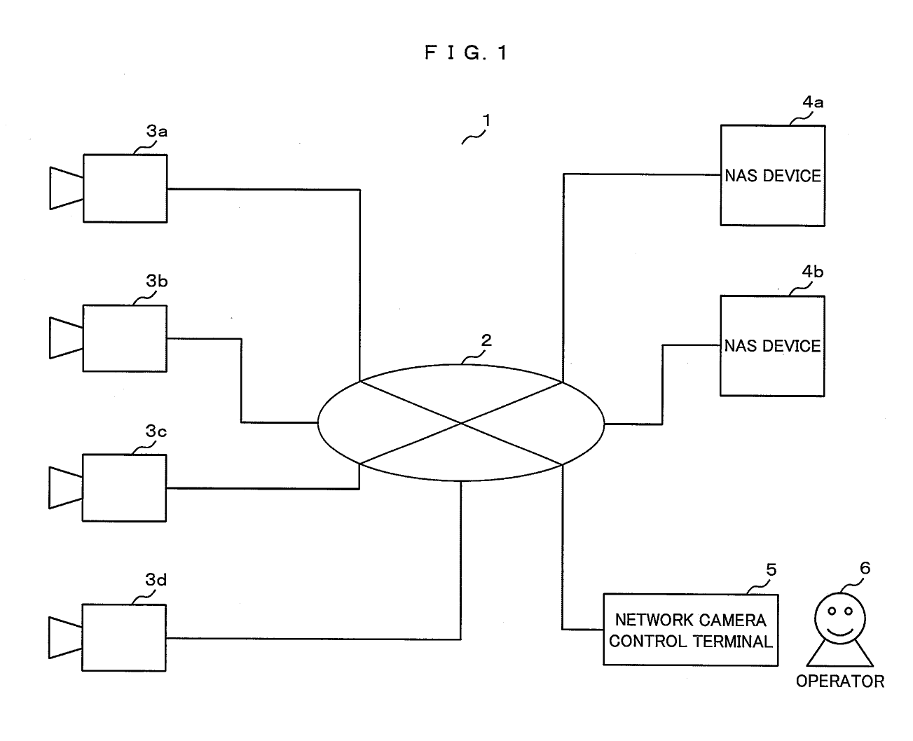

FIG. 1 is a diagram illustrating an exemplary configuration of the video recording/delivering system 1 according to the present embodiment.

The video recording/delivering system 1 according to the present embodiment includes a data communication network 2, network cameras 3a, 3b, 3c, and 3d (hereinafter, referred to as a “network camera 3” when not particularly designated), network attached storage (NAS) devices (data recording devices) 4a and 4b (hereinafter, referred to as a “NAS device 4” when not particularly designated), and a network camera control terminal 5. The network camera 3, the NAS device 4, and the network camera control terminal 5 are connected to the data communication network 2 and can communicate with one another via the data communication network 2.

Examples of the data communication network 2 include a wireless or wired local area network (LAN), the Internet configured by connecting LANs, and a mobile telephone network.

The network camera 3 is connected to the data communication network 2 in a wired or wireless manner, and can deliver captured moving image data to the NAS device 4 which will be described later or the network camera control terminal 5 via the data communication network 2 using a common general-purpose protocol for transmission and reception of a file which will be described later or a dedicated protocol specific to the video recording/delivering system. The network camera control terminal 5 sets various functions of the network camera 3 via the data communication network 2 using the dedicated protocol specific to the video recording/delivering system. Examples of the network camera 3 include a monitoring camera, a camera for a video conference system, a camera for game connection, and a video phone camera.

The NAS device 4 is connected to the data communication network 2 in a wired or wireless manner, and can perform transmission and reception of a file with the network camera 3 or the network camera control terminal 5 which will be described later via the data communication network 2 using the common general-purpose protocol for transmission and reception of a file via a network such as a network file system (NFS), a server message block (SMB), a common internet file system (CIFS), or a web-based distributed authoring and versioning (WebDAV). Data received by the NAS device 4 using the general-purpose protocol can be stored as a file, and a designated file can be read according to a request using the general-purpose protocol and transmitted using the protocol via the network. Examples of the NAS device 4 include a dedicated appliance equipped with a hard disk drive (HDD), a computer including the protocol, and a server device. The NAS device 4 does not include a function of executing the dedicated protocol specific to the video recording/delivering system.

The network camera control terminal 5 can set various functions provided by the network camera 3, request moving image data, and receive the moving image data in a wired or wireless manner via the data communication network 2 using the dedicated protocol specific to the video recording/delivering system, and can perform transmission and reception of a file with the NAS device 4 using the common protocol for transmission and reception of a file. The network camera control terminal 5 is configured with one or more devices, and examples of the network camera control terminal 5 include a personal computer, a server device, a system in which a set top box and a monitor are combined, and a dedicated appliance.

An operator 6 performs various kinds of settings of the network camera 3, refers to various kinds of setting information of the network camera 3, and refers to moving image data to be delivered from the network camera 3 by performing various kinds of operations while referring to a monitor of the network camera control terminal 5 or the like.

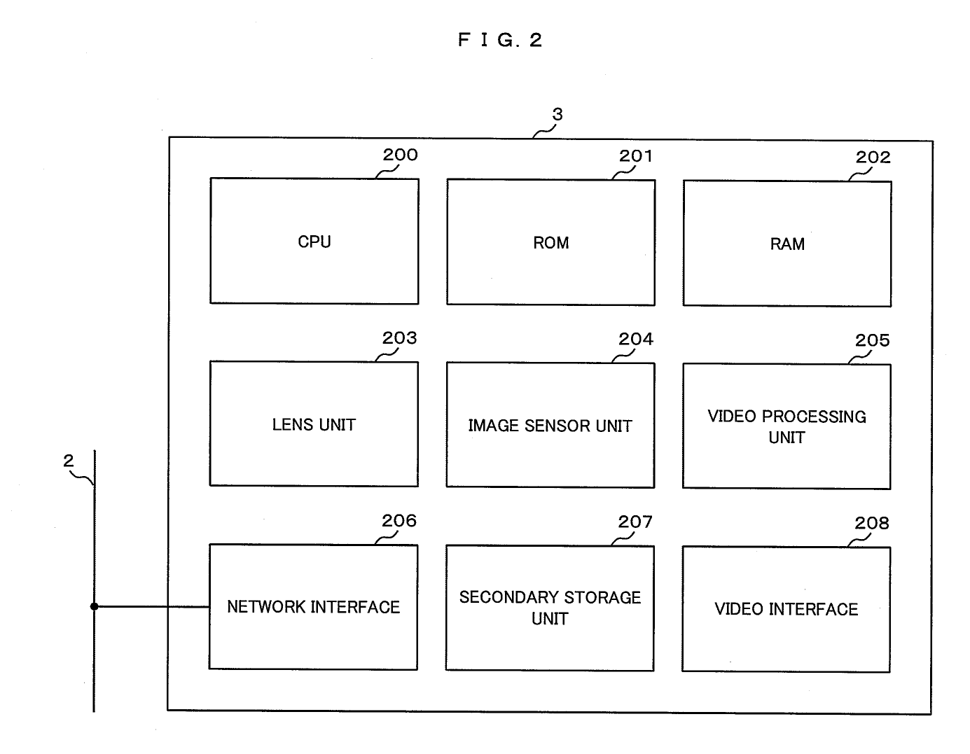

FIG. 2 is a diagram illustrating a hardware configuration of the network camera 3 according to the present embodiment. The network camera 3 includes a central processing unit (CPU) 200 that controls the network camera 3 in general, a read only memory (ROM) 201 and a random access memory (RAM) 202 that store data or a program, a lens unit 203 including an optical lens, an image sensor unit 204 that detects light obtained by the lens unit. 203 and converts the detected light into digital data, a video processing unit 205 that processes the digital data or the like obtained by the image sensor unit 204 as moving image data, a network interface 206 that transmits or receives data to or from the data communication network 2 in a wired or wireless manner, a secondary storage unit 207 in which it is possible to record or delete data, and a video interface 208 for outputting the moving image data obtained by the video processing unit 205 to the outside. Depending on the form of the network camera 3, the secondary storage unit 207 in which it is possible to record or delete data may be a HDD, a solid state drive (SSD), a removable memory card, or the like or may not be arranged.

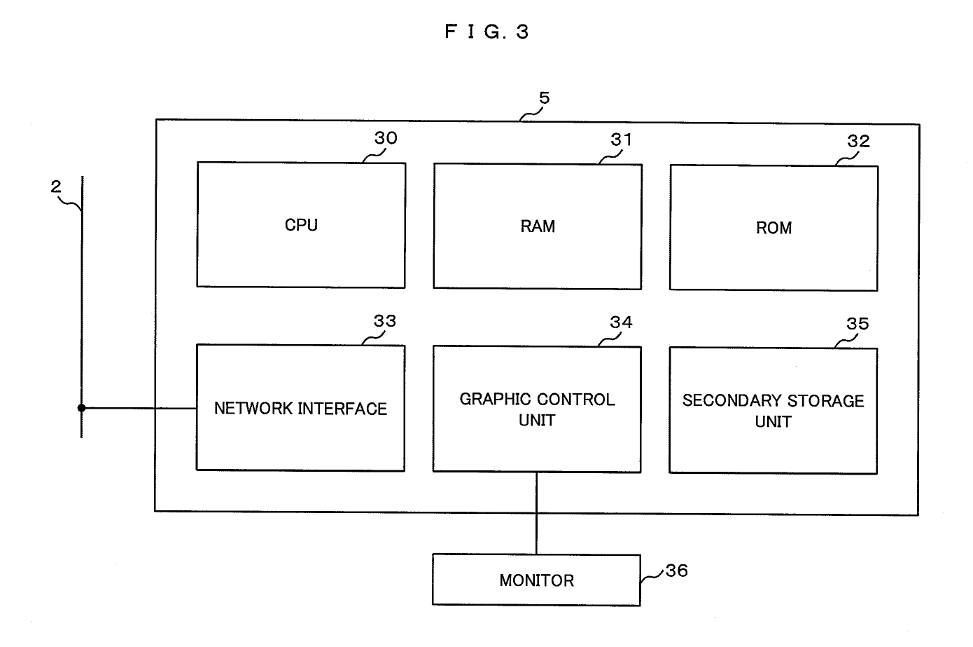

FIG. 3 is a diagram illustrating a hardware configuration of the network camera control terminal 5 according to the present embodiment. The network camera control terminal 5 includes a CPU 30 that controls the network camera control terminal 5 in general, a RAM 31 and a ROM 32 that store data or a program, a network interface 33 that transmits or receives data to or from the data communication network 2 in a wired or wireless manner, a graphic control unit 34 that performs control such that information is displayed on a monitor 36 which will be described later, a secondary storage unit 35 in which it is possible to record and delete data, and the monitor (display unit) 36 capable of displaying various information through a screen. Depending on the form of the network camera control terminal 5, the secondary storage unit 35 in which it is possible to record and delete data may be a HDD, an SSD, a memory card, or the like.

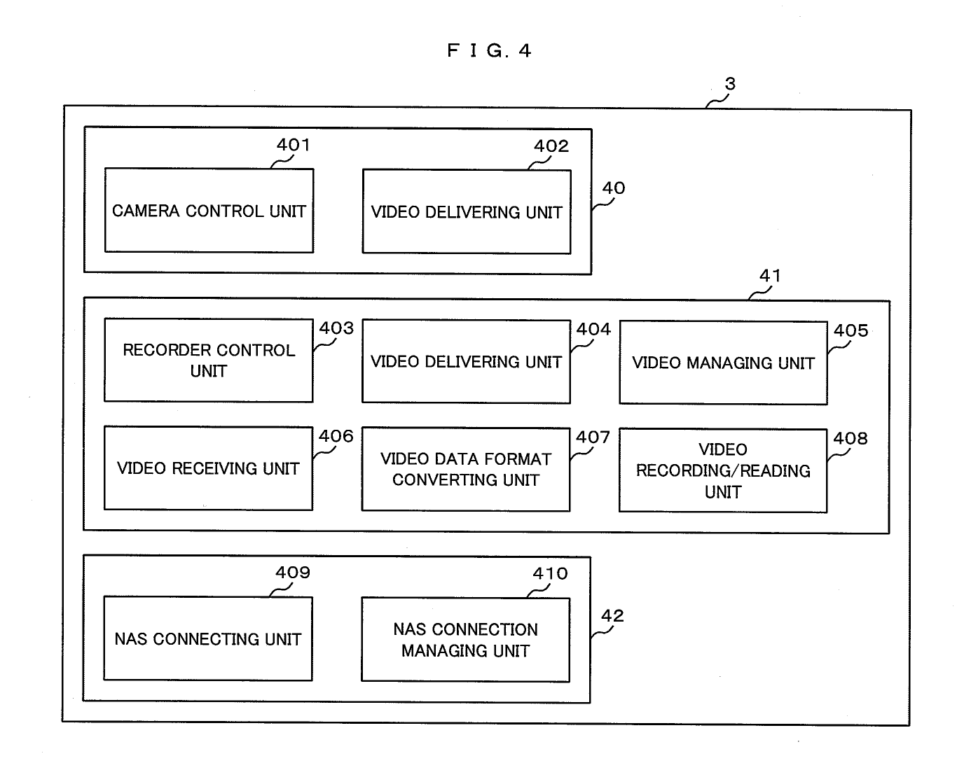

FIG. 4 is a diagram illustrating functional blocks of the network camera 3 according to the present embodiment.

The network camera 3 includes a camera protocol unit 40 configured with a camera control unit 401 and a video delivering unit 402, a recorder protocol unit 41 configured with a recorder control unit 403, a video delivering unit 404, a video managing unit 405, a video receiving unit 406, a video data format converting unit 407, and a video recording/reading unit 408, and a NAS collaborating unit 42 configured with a NAS connecting unit 409 and a NAS connection managing unit 410.

The camera protocol unit 40 is a dedicated protocol specific to the video recording/delivering system that undertakes a camera function of the network camera 3.

The camera control unit 401 sets and controls various kinds of video relevant functions of, for example, the image sensor unit 204 arranged in the network camera 3 or the video processing unit 205 that adjusts, for example, a resolution or a frame rate of video data delivered through the video delivering unit 402 which will be described later or various kinds of system functions of the network interface 206, the video interface 208, or the like according to a request from the network camera control terminal 5.

The video delivering unit 402 delivers the moving image data obtained by the video processing unit 205 to the network camera control terminal 5 or the video receiving unit 406 according to a request from the network camera control terminal 5 or the video receiving unit 406 that has received an instruction given from the network camera control terminal 5. The moving image data is live video data being captured by the lens unit 203. The video data to be delivered to the network camera control terminal 5 is displayed on the monitor 36 of the network control terminal 5. The video data to be delivered to the video receiving unit 406 is recorded and stored in the NAS device 4 through the video data format converting unit 407 and the video recording/reading unit 408.

The recorder protocol unit 41 is a dedicated protocol specific to the video recording/delivering system that undertakes a recorder function of the network camera 3.

The recorder control unit 403 sets and controls the recorder relevant function of the network camera 3 and various kinds of video relevant functions of the video processing unit 205 that adjusts, for example, a resolution or a frame rate of video data to be delivered through the video delivering unit 404 which will be described later according to a request from the network camera control terminal 5.

The video delivering unit 404 acquires designated video data from the video data format converting unit 407 which will be described later and delivers the acquired video data to the network camera control terminal 5 according to a request from the network camera control terminal 5. The video data to be acquired from the video data format converting unit 407 is read from the NAS device 4 via the NAS connecting unit 409 through the video recording/reading unit 808 and transferred to the video data format converting unit 407.

The video managing unit 405 reads and write a list of video data stored in the NAS device 4 to which the NAS connecting unit 409 is connected through the NAS connecting unit 409 which will be described later, and manages a list of video data recorded and stored in the NAS device 4 through the video recording/reading unit 408 which will be described later.

The video receiving unit 406 receives an instruction from the network camera control terminal 5, makes a video data request to the video delivering unit 402 of the camera protocol unit 40 of the network camera 3, and receives the video data delivered from the video delivering unit 402.

The video data format converting unit 407 converts the video data received through the video receiving unit 406 to have a data format that is recorded in the NAS device 4 through the video recording/reading unit 408 which will be described later, and converts the video data read from the NAS device 4 through the video recording/reading unit 408 which will be described later to have a data format that is delivered through the video delivering unit 404. The video data read from the NAS device 4 is temporarily recorded in the secondary storage unit 207 or the like.

The video recording/reading unit 408 records and stores video data having a format acquired from the video data format converting unit 407 in the NAS device 4 to which the NAS connecting unit 409 is connected through the NAS connecting unit 409 which will be described later. The video recording/reading unit 408 reads the video data designated in the video delivering unit 404 from the NAS device 4 to which the NAS connecting unit 409 is connected through the NAS connecting unit 409 which will be described later, and transfers the read video data to the video data format converting unit 407.

The NAS collaborating unit 42 is connected with the NAS device 4 connected to the video recording/delivering system 1 using the common protocol for transmission and reception of a file, and provides a function for transmitting and receiving data.

The NAS connecting unit 409 is connected with the NAS device 4 that is designated by the NAS connection managing unit 410 which will be described later and connected to the video recording/delivering system 1, performs transmission and reception of data with the NAS device 4, and provides a function of recording and reading data through the video managing unit 405 or the video recording/reading unit 408.

The NAS connection managing unit 410 transfers an IP address of the NAS device 4 designated to the network camera control terminal 5 and a mount point indicating a predetermined directory to be referred to to the NAS connecting unit 409 according to an instruction given from the network camera control terminal 5, and gives a connection instruction or a disconnection instruction.

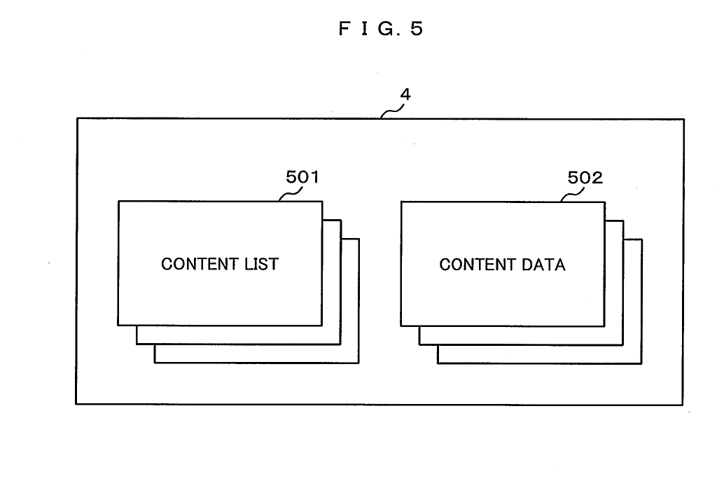

The processing units 401 to 410 implement the functions using the functions of the image sensor unit 204, the video processing unit 215, and the network interface 206 as a program stored in the secondary storage unit 207 or the ROM 201 is developed onto the RAM 202 and executed by the CPU 200. FIG. 5 is a diagram illustrating a state of a file in which data stored in the NAS device 4 is described according to the present embodiment.

A content list 501 is a content list file in which the video managing unit 405 of the network camera 3 has recorded information such as a file name of content that the video recording/reading unit 408 of the network camera 3 has recorded and stored in the NAS device 4 through the NAS connecting unit 409 through the NAS connecting unit 409 for each network camera 3. The video managing unit 405 of the network camera 3 can refer to the content list 501 through the NAS connecting unit 409.

Content data 502 is a file group of video data that the video recording/reading unit 408 of the network camera 3 has stored through the NAS connecting unit 409. The video recording/reading unit 408 of the network camera 3 can acquire the content data 502 through the NAS connecting unit 409.

The content list 501 and the content data 502 are recorded and stored in the NAS device 4 in the form of a file, and as the network camera 3 is connected to the NAS device 4 via the NAS connecting unit 409 of the network camera 3, the network camera 3 enters a readable/writable state through the data communication network 2.

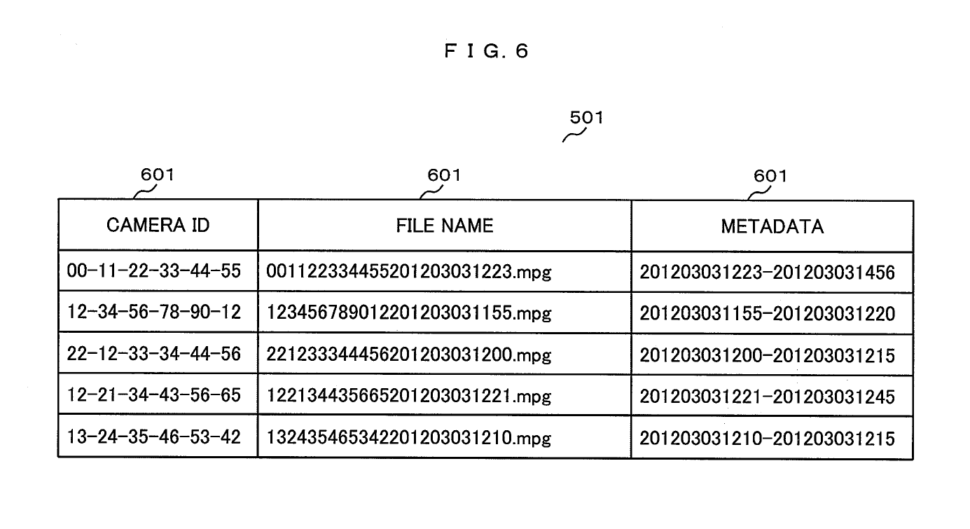

FIG. 6 is a diagram illustrating the content list 501 recorded in the file stored in the NAS device 4 according to the present embodiment.

The content list 501 includes a camera ID 601, a file name 602, and metadata 603.

The camera ID 601 is a unique identifier in the video recording/delivering system 1 which identifies the network camera 3 that has transmitted video data stored as the content data 502.

The file name 602 is a file name specifying a file configured with one or more pieces of data stored as the content data 502.

The metadata 603 is various kinds of detailed information related to video data such as a shooting date and time of video data stored as the content data 502.

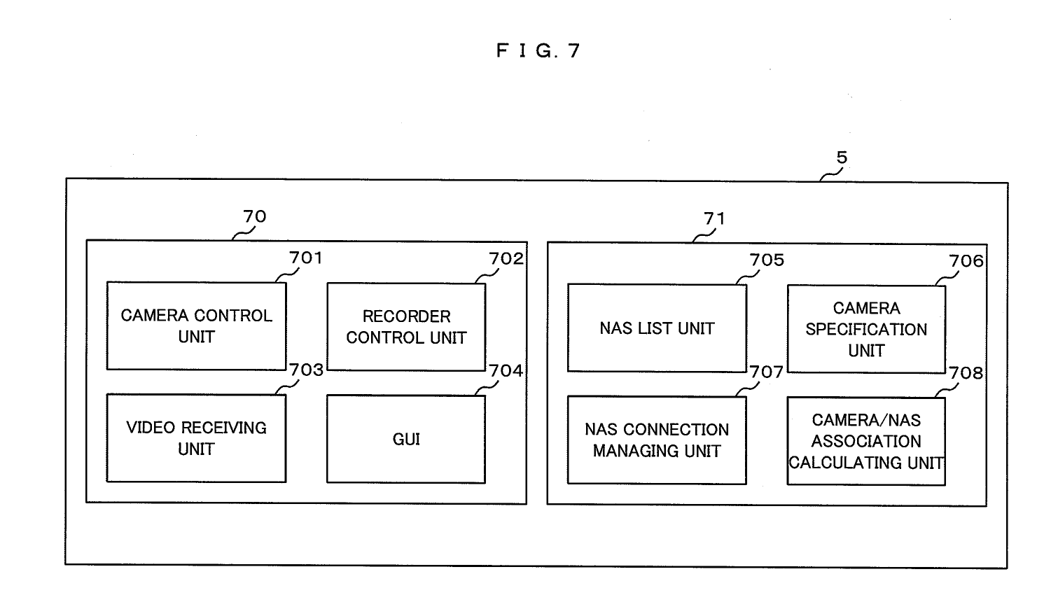

FIG. 7 is a diagram illustrating functional blocks of the network camera control terminal 5 according to the present embodiment.

The network camera control terminal 5 includes a camera/recorder protocol unit 70 configured with a camera control unit 701, a recorder control unit 702, a video receiving unit 703, and a GUI unit 704 and a NAS collaboration control unit 71 configured with a NAS list unit 705, a camera specification unit 706, a NAS connection managing unit 707, and a camera/NAS association calculating unit 708.

The camera/recorder protocol unit 70 is a dedicated protocol specific to the video recording/delivering system that controls a camera function and a recorder function of the network camera 3.

The camera control unit 701 performs communication with the camera control unit 401 of the network camera 3 via the data communication network 2, and sets and controls various kinds of video relevant functions or various kinds of system functions of the network camera 3.

The recorder control unit 702 performs communication with the recorder control unit 403 of the network camera 3 via the data communication network 2, and sets and controls the recorder relevant function of the network camera 3. The recorder control unit 702 instructs and controls the video receiving unit 406 of the network camera 3 such that the video receiving unit 406 receives the video data from the video delivering unit 402 of the network camera 3. The recorder control unit 702 requests the video managing unit 405 of the network camera 3 to provide a video data list via the data communication network 2, and acquires the video data list.

The video receiving unit 703 requests the video delivering unit 402 of the camera protocol unit 40 of the network camera 3 or the video delivering unit 404 of the recorder protocol unit 41 to provide designated video data, and receives the video data delivered from the video delivering unit 404 via the data communication network 2. The GUI unit 704 processes the video data received from a plurality of network cameras 3 by the video receiving unit 703 through the graphic control unit 34 of the network camera control terminal 5, and causes, for example, a multi-screen configuration divided into a plurality of regions having different sizes to be displayed on the monitor 36 of the network camera control terminal 5 in a video display format 80 (which will be described later) desired by the operator 6.

The NAS collaboration control unit 71 performs communication with the NAS collaborating unit 42 of the network camera 3 via the data communication network 2, and has a function of setting and controlling a connection combination of the network camera 3 and the NAS device 4 connected to the video recording/delivering system 1.

The NAS list unit 705 manages a set of a unique identifier and an IP address of the NAS device 4 connected to the video recording/delivering system 1. As a method of detecting the IP address of the NAS device 4, there are a method using an input of the operator or the like and a method of detecting through automatic exchange with the NAS device 4 using communication based on a multicast address or the like, but a means thereof is not consequential.

The camera specification unit 706 detects and manages specification information of the network camera 3 that is decided in advance for each model of the network camera 3 such as simultaneous delivery performance and a simultaneous processing capability of the network camera 3 connected to the video recording/delivering system 1. The specification information of each model of the network camera 3 may be input and set in advance or may be detected appropriately through exchange with the network camera 3, but a means thereof is not consequential.

The NAS connection managing unit 707 transfers the IP address of the NAS device 4 to which the network camera 3 is connected and the mount point indicating the directory in which the content list 501 and the content data 502 are stored to the NAS connection managing unit 410 of each network camera 3 via the data communication network 2 according to a combination of the network camera 3 and the NAS device 4 designated by the camera/NAS association calculating unit 708 which will be described later.

The camera/NAS association calculating unit 708 compares, for example, a setting state of an encoder or an operation state such as video delivery at a current point in time in each network camera connected to the video recording/delivering system 1, which is performed through the camera control unit 701 or the recorder control unit 702 of the camera/recorder protocol unit 70 of the network camera control terminal 5 with the specification information described in the camera specification unit 706, detects the network camera 3 having an enough capacity in the simultaneous delivery performance, the simultaneous processing capability, or the like, and decides a combination of the network camera 3 having an enough capacity and the NAS device 4 including the mount point indicating the directory in which the content list corresponding to the video data recorded by each network camera 3 is stored so that the simultaneous delivery performance or the simultaneous processing capability of the network camera 3 is not exceeded.

The processing units 701 to 708 are implemented as a program stored in the secondary storage unit 35 or the ROM 32 is developed onto the RAM 31 and executed by the CPU 30.

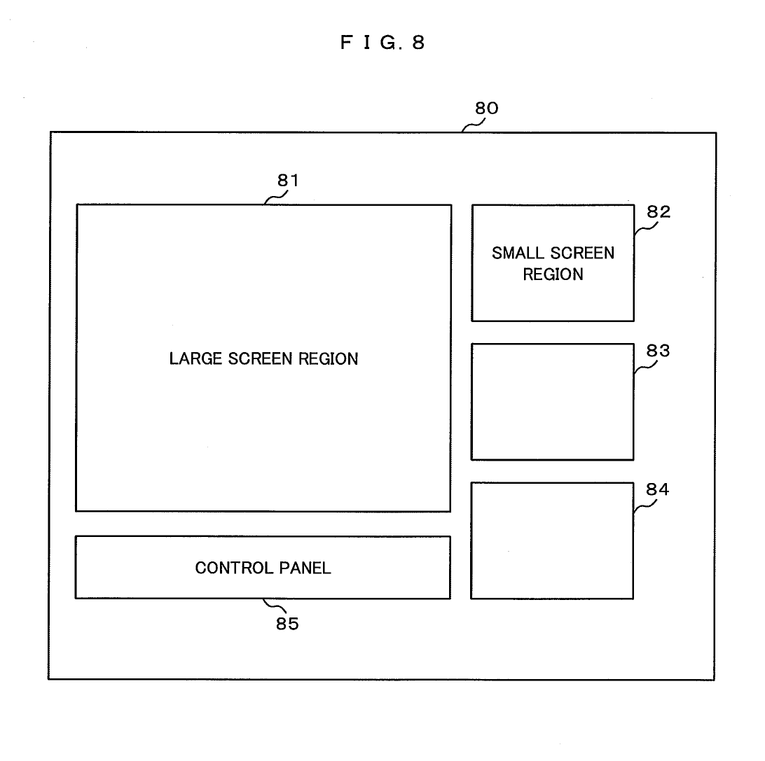

FIG. 8 is a diagram illustrating the video display format 80 processed by the GUI unit 704 of the network camera control terminal on the screen of the monitor 36 of the network camera control terminal 5 according to the present embodiment.

In the video display format 80, one screen is divided into four video data display regions, and the video data delivered from the video delivering units 402 of the camera protocol units 40 or the video delivering units 404 of the recorder protocol units 41 of the different network cameras 3 is displayed on the respective regions.

A large screen region 81 displays video data that has a higher resolution and a higher frame rate than small screen regions 82 to 84 which will be described later and is delivered from the video delivering unit 402 of the camera protocol unit 40 of the network camera 3 selected by the operator 6 or the video delivering unit 404 of the recorder protocol unit 41 of the network camera 3 that delivers content data of video data selected by the operator 6.

The small screen regions 82 to 84 displays video data that has a lower resolution and a lower frame rate than the large screen region 81 and is delivered from the video delivering unit 402 of the camera protocol unit 40 of the network camera 3 selected by the operator 6 or the video delivering unit 404 of the recorder protocol unit 41 of the network camera 3 that delivers content data of video data selected by the operator 6 in the video recording/delivering system 1.

A control panel 85 includes a user interface through which the operator 6 performs an operation of designating desired video data in the camera control unit 401, the recorder control unit 403, the video delivering unit 402, or the video delivering unit 404 of the network camera 3.

In the video display format 80, the number of divided regions, a combination of a plurality of large and small regions, a resolution (a screen size) of video data displayed for each region, a frame rate, and the like are not limited to the example of the present embodiment and may be an arbitrary combination.

(System Process)

Next, the details of processes in the network camera 3 and the network camera control terminal 5 according to the present embodiment will be described. As a result, when switching of a correspondence relation between video data delivered by the network camera 3 in the video recording/delivering system 1 and the screen regions 81 to 84 that display the video data in the video display format 80 is performed according to an operation of the operator 6, a method in which video data recorded in the NAS device 4 can be referred to in the entire video recording/delivering system 1 regardless of how switching is performed is explicitly implemented.

Network Camera Process

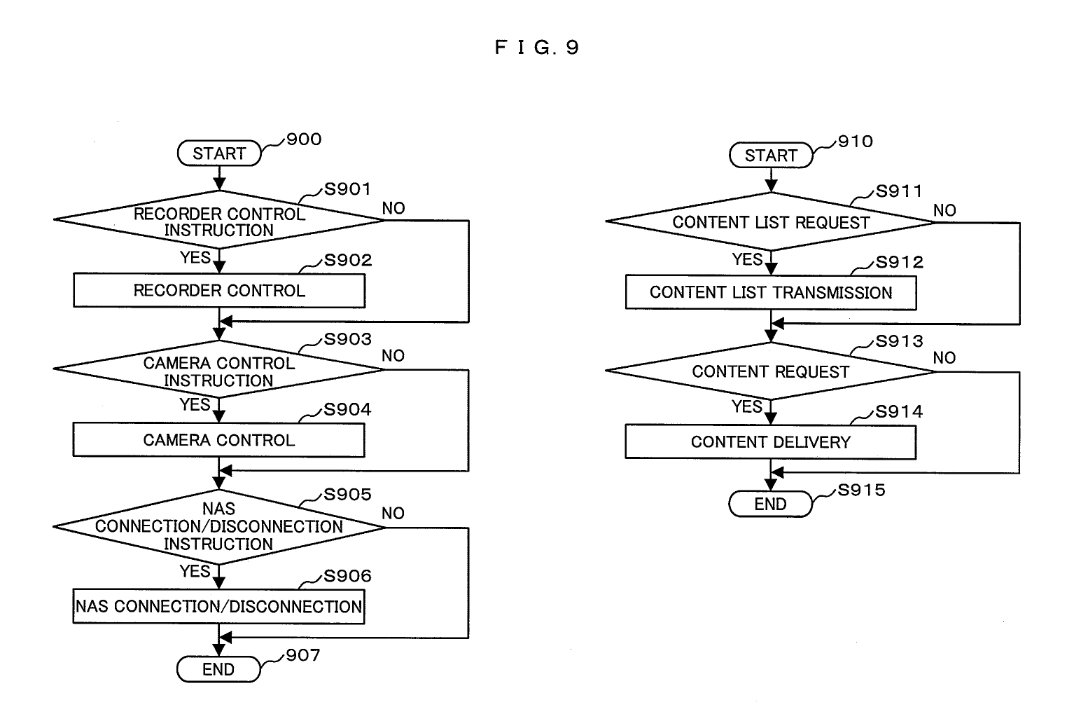

FIG. 9 is a diagram for describing the flow of a network camera process in the network camera 3. As the network camera process in the network camera 3, a network camera process 900 and a network camera process 910 are executed in parallel, and each process is repeatedly executed.

In S901, the recorder control unit 403 of the network camera 3 is on standby for a setting/control request for the recorder relevant function of the network camera 3 which is transmitted from the recorder control unit 702 of the network camera control terminal 5, the video receiving unit 406 of the network camera 3 is on standby for an instruction to make a video data delivery request to the video delivering unit 402 of the network camera 3 which is transmitted from the recorder control unit 702 of the network camera control terminal 5, and the NAS connection managing unit 410 of the network camera 3 is on standby for an instruction of the IP address of the NAS device 4 at which video data is written by the video recording/reading unit 408 of the network camera 3 and the mount point indicating a predetermined directory which is transmitted from the NAS connection managing unit 707 of the network camera control terminal 5, and when the requests are received, the process proceeds to S902, whereas when the requests are not received, the process proceeds to S903.

In S902, the recorder control unit 403 of the network camera 3 performs various kinds of settings and control for the network camera 3 according to the setting/control request for the recorder relevant function received from the recorder control unit 702 of the network camera control terminal 5. The video receiving unit 406 of the network camera 3 makes the video data delivery request received from the recorder control unit 702 of the network camera control terminal 5 to the video delivering unit 402 of the network camera 3, and makes the video data delivery request to the video delivering unit 402 of the network camera 3. The NAS connection managing unit 410 of the network camera 3 establishes a connection with the IP address of the NAS device 4 at which the video data is written by the video recording/reading unit 408 of the network camera 3 and the mount point indicating the predetermined directory which are designated from the NAS connection managing unit 707 of the network camera control terminal 5 through the NAS connecting unit 409 of the network camera 3. The connection with the NAS device 4 has to be established before the video receiving unit 406 of the network camera 3 makes the video data delivery request to the video delivering unit 402 of the network camera 3. As a result, after the process of S902 ends, the video data received by the video receiving unit 406 of the network camera 3 can start to be recorded in the NAS device 4 connected to write the video data as the content data 502, and the information such as the file name of the video data can be appropriately recorded as the content list 501.

In S903, the camera control unit 401 of the network camera 3 is on standby for the setting/control request for various kinds of video relevant functions or various kinds of system functions of the encoder of the network camera 3 or the like which is transmitted from the camera control unit 701 of the network camera control terminal 5, and the video receiving unit 402 of the network camera 3 is on standby for the video data delivery request from the video receiving unit 703 of the network camera control terminal 5 or the video data delivery request from the video receiving unit 406 of the network camera 3, and when the requests are received, the process proceeds to S904, whereas when the requests are not received, the process proceeds to S905.

In S904, the camera control unit 401 of the network camera 3 performs various kinds of settings and control for the network camera 3 according to the setting/control request for various kinds of video relevant functions [symbol] various kinds of system functions of the encoder or the like which is received from the camera control unit 701 of the network camera control terminal 5. In the present setting and control, various kinds of settings such as the resolution and the frame rate of the video data delivered through the video delivering unit 402 of the network camera 3 are performed, and the process proceeds to S905. The video receiving unit 402 of the network camera 3 delivers the requested video data according to the video data delivery request received from the video receiving unit 703 of the network camera control terminal 5 or the video receiving unit 406 of the network camera 3, and then the process proceeds to S095.

In S905, the NAS connection managing unit 410 of the network camera 3 is on standby for a connection instruction or a disconnection instruction for the NAS device 4 corresponding to the network camera 3 which is given from the NAS connection managing unit 707 of the network camera control terminal 5, and when the instruction is received, the process proceeds to S906, whereas the instruction is not received, the process proceeds to S907.

In S906, the NAS connecting unit 409 of the network camera 3 establishes or disconnects the connection with the NAS device 4 corresponding to the network camera 3 according to the instruction received by the NAS connection managing unit 410 of the network camera 3, and then the process proceeds to S907.

When the process of S907 ends, the network camera process 900 is executed again and repeated.

In S911, the video managing unit 405 of the network camera 3 is on standby for a request for a content list of the video data of the NAS device 4 to which the network camera 3 is connected for reading which is transmitted from the recorder control unit 702 of the network camera control terminal 5, and when the request is received, the process proceeds to S912, whereas when the request is not received, the process proceeds to S913.

In S912, the video managing unit 405 of the network camera 3 transmits to the recorder control unit 702 of the network camera control terminal 5 via the data communication network 2 according to the video data list request received from the recorder control unit 702 of the network camera control terminal 5, and the process proceeds to S913.

In S913, the video delivering unit 404 of the network camera 3 is on standby for a delivery request for the video data stored in the NAS device 4 to which the NAS connecting unit 409 of the network camera 3 is connected to read the video data which is transmitted from the video receiving unit 703 of the network camera control terminal 5, and when the delivery request is received, the process proceeds to S914, whereas the delivery request is not received, the process proceeds to S915.

In S914, the video delivering unit 404 of the network camera 3 reads the designated video data from the NAS device 4 through the video recording/reading unit 408 of the network camera 3 according to the video data delivery request received from the video receiving unit 703 of the network camera control terminal 5, and the video delivering unit 404 of the network camera 3 transmits the video data acquired from the video data format converting unit 407 of the network camera 3 to the video receiving unit 703 of the network camera control terminal 5 via the data communication network 2, and then the process proceeds to S915.

The process of S915 ends, and the network camera process 910 is executed again and repeated.

The flow of the network camera process in the network camera 3 has been described above.

Network Camera Control Terminal Process

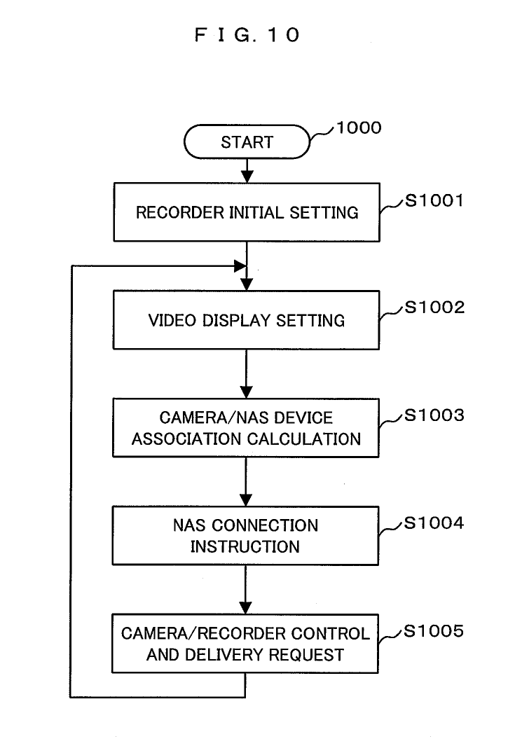

FIG. 10 is a diagram for describing the flow of a network camera control terminal process 1000 in the network camera control terminal 5. The network camera control terminal process 1000 in the network camera control terminal 5 is executed continuously after the network camera control terminal 5 is activated.

In S1001, the recorder control unit 702 of the network camera control terminal 5 makes an initial setting/control request for the recorder relevant function of the network camera 3 to the network camera 3 connected thereto in the video recording/delivering system 1. The NAS connection managing unit 707 of the network camera control terminal 5 designates the NAS device 4 in which the video data is written by the video recording/reading unit 408 of the network camera 3, and notifies the NAS connection managing unit 410 of the network camera 3 of the designated NAS device 4. The process proceeds to S1002.

In S1002, the operator 6 performs an operation for designating and allocating video data that is delivered from the video delivering unit 402 of the camera protocol unit 40 or the video delivering unit 404 of the recorder protocol unit 41 of each network camera 3 and projected onto the large screen region 81 and the small screen regions 82 to 84 in the video display format 80 of the GUI unit 704 of the network camera control terminal 5, and then the process proceeds to S1003. Through the allocation operation, for example, video data in which the operator 6 is particularly interested is allocated to the large screen region 81, the network camera 3 that delivers video data to be displayed is selected when a plurality of network cameras 3 are connected in the video recording/delivering system 1, and video data delivered by the network camera 3 is allocated to the small screen regions 82 to 84, and the allocation is changed continually and repeated by the operation of the operator 6 or the like.

In S1003, the camera/NAS association calculating unit 708 of the network camera control terminal 5 compares the setting state of the network camera 3 connected to the video recording/delivering system 1 which has been set in S1001 with the specification information of the network camera 3 which has been decided in advance for each model of the network camera 3 and described in the camera specification 706 such as the simultaneous delivery performance or the simultaneous processing capability of the network camera 3, checks the network camera 3 that has an enough capacity in the simultaneous delivery performance or the simultaneous processing capability, and associates the network camera 3 having an enough capacity, the IP address of the NAS device 4 described in the NAS list unit 705 of the network camera control terminal 5, and the mount point indicating the directory including the specific content list 501 and the content data 502 as the NAS device 4 for video data reading, and the process proceeds to S1004. When it is determined that there is an enough capacity in the simultaneous delivery performance or the simultaneous processing capability of the network camera 3 in the process of S1003 continuously even after S1002 is executed, the correspondence relation with the NAS device 4 associated with the network camera 3 calculated when S1003 is executed last time may be maintained.

In S1004, the NAS connection managing unit 707 of the network camera control terminal 5 notifies the NAS connection managing unit 410 of the network camera 3 of the IP address of the NAS device 4 for video data reading associated with the network camera 3 and the mount point indicating the directory including the specific content list 501 and the content data 502 which are calculated in S1003, and then the process proceeds to S1005.

In S1005, the camera control unit 701 of the network camera control terminal 5 sets, for example, a screen region allocated for displaying the video data and a resolution and a frame rate corresponding to a setting of the operator 6 to the camera control unit 401 of the network camera 3 that delivers the video data corresponding to any one of the large screen region 81 and the small screen regions 82 to 84 in the video display format 80 of the GUI unit 704 of the network camera control terminal 5 through the allocation operation of the operator 6, and makes the video data delivery request to the video delivering unit 402 of the network camera 3. The recorder control unit 702 of the network camera control terminal 5 sets, for example, a screen region allocated for displaying the video data and a resolution and a frame rate corresponding to a setting of the operator 6 to the recorder control unit 403 of the network camera 3 associated with and connected with the NAS device 4 for reading through the allocation operation of the operator 6 when the video data recorded in the NAS device 4 in the video recording/delivering system 1 is included in any one of the large screen region 81 and the small screen regions 82 to 84 in the video display format 80 of the GUI unit 704 of the network camera control terminal 5, makes the video data delivery request to the video delivering unit 404 of the network camera 3, and then the process proceeds to S1002, and the subsequent process is repeatedly executed.

As a result, the corresponding video data desired by the operator 6 is copied onto each of the large screen region 81 and the small screen regions 82 to 84 in the video display format 80 of the GUI unit 704 of the network camera control terminal 5.

The flow of the network camera control terminal process 1000 in the network camera control terminal 5 has been described above.

Connection of Network Camera and NAS Device

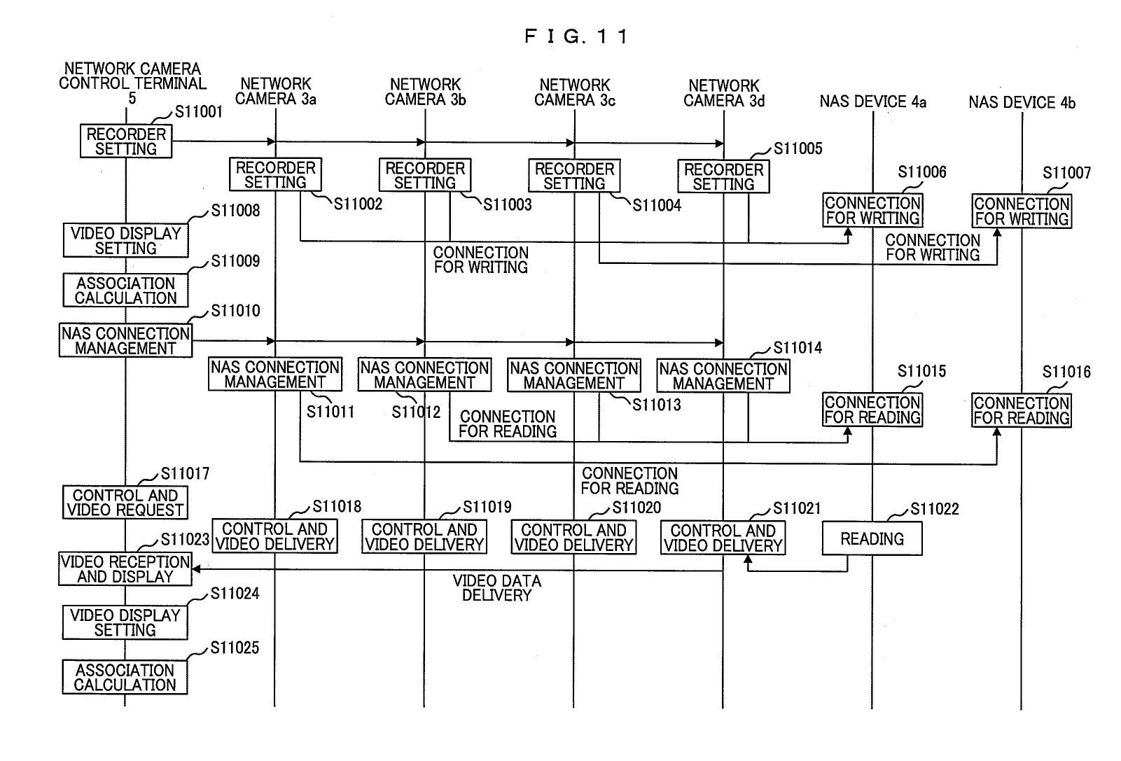

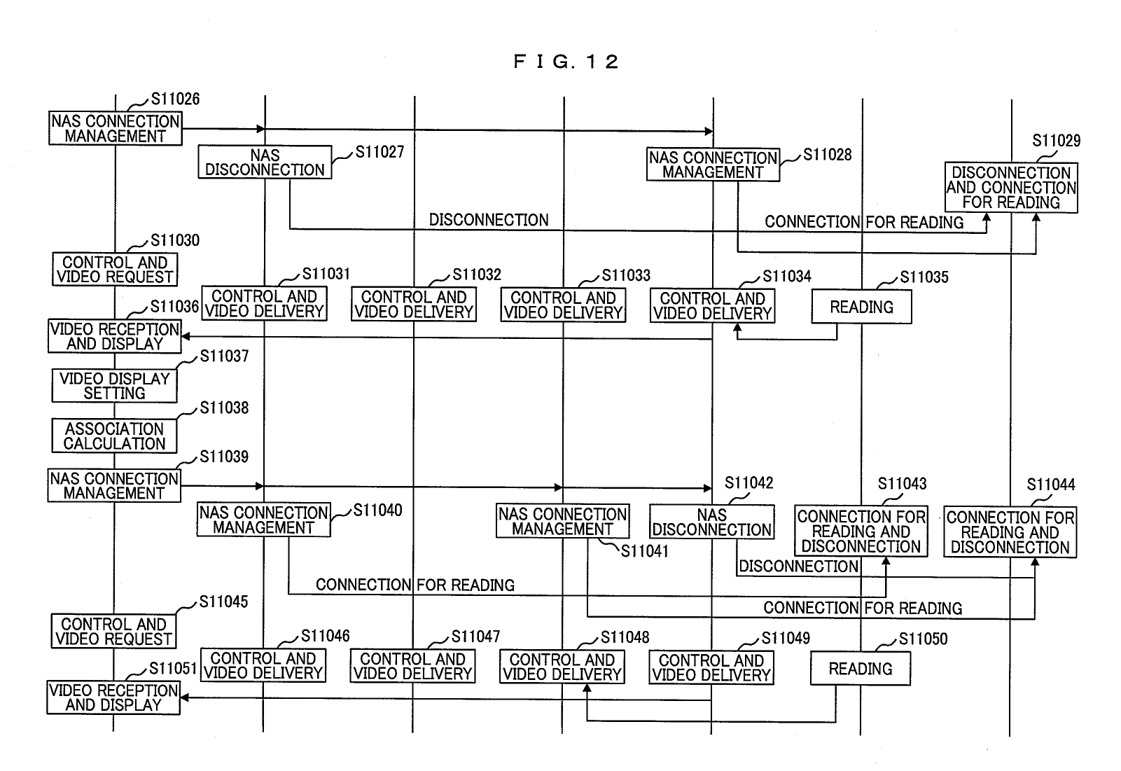

FIGS. 11 and 12 are diagrams for describing the flow of a series of processes until the recording/delivery function provided by the video recording/delivering system is implemented using the NAS device 4 by dynamically changing the connection configuration of each device in the video recording/delivering system 1 with reference to the setting state of the network camera 3 connected to the video recording/delivering system 1.

The network cameras 3a to 3d execute the network camera process 900 and the network camera process 910, and the network camera control terminal 5 executes the network camera control terminal process 1000.

In the present embodiment, the network camera 3 is assumed to have the simultaneous delivery performance and the simultaneous processing capability in which when video data is delivered with a preferred setting to be displayed on the large screen region 81, simultaneous recording can be performed in the NAS device 4 for writing associated with the network camera 3, and when video data is delivered with a preferred setting to be displayed on any one of the small screen regions 82 to 84, simultaneous recording can be performed in the NAS device 4 for writing associated with the network camera 3, and video data can be delivered with a preferred setting so that the video data recorded in the NAS device 4 for reading associated with the network camera 3 is displayed on any one of the small screen regions 82 to 84. Further, in the present embodiment, the NAS device 4 is assumed to have performance capable of supporting a simultaneous reading process or a simultaneous writing process on a plurality of network cameras regardless of whether the NAS device 4 has a reading connection or a writing connection.

The specification such as the simultaneous delivery performance or the simultaneous processing capability of the network camera 3 is various, and the video display format 80 can have various forms according to the number of regions or the size of the screen region as well. For example, the number of the network cameras 3, the number of the NAS devices 4, and the number of the network camera control terminals 5 connected to the video recording/delivering system 1 have various combinations, and are not limited to the present embodiment described below.

In the present embodiment, the process is assumed to start when the operator 6 sets the recorder function of the network camera 3 in the video recording/delivering system 1 using the network camera control terminal 5.

In S11001, the network camera control terminal 5 performs the process of S1001 through the recorder control unit 701 of the network camera control terminal 5 according to the setting/operation of the operator 6 or the like.

In S11002 to S11005, in the network cameras 3a to 3d, the recorder control units 403 of the network cameras 3a to 3d receive the request of S11001 through the process of S901, and the network cameras 3a to 3d perform the initial setting and control for the recorder relevant function in S902. The NAS connecting unit 409 of the network camera 3a establishes a connection with the NAS device 4a in which live video data currently being projected by the lens unit 203 of the network camera 3a is written, the NAS connecting unit 409 of the network camera 3b designates the NAS device 4a in which live video data currently being projected by the lens unit 203 of the network camera 3b is written, the NAS connecting unit 409 of the network camera 3c establishes a connection with the NAS device 4b in which live video data currently being projected by the lens unit 203 of the network camera 3c is written, and the NAS connecting unit 409 of the network camera 3d establishes a connection with the NAS device 4b in which live video data currently being projected by the lens unit 203 of the network camera 3d is written.

In S11006, the NAS device 4a accepts the connection from the NAS connecting units 409 of the network cameras 3a and 3b through the process of S11002 and S11003, and enters a state in which writing from the video recording/reading units 408 of the network cameras 3a and 3b is possible.

In S11007, the NAS device 4b accepts the connection from the NAS connecting units 409 of the network cameras 3c and 3d through the process of S11004 and S11005, and enters a state in which writing from the video recording/reading units 408 of the network cameras 3c and 3d is possible.

In S11008, the operator 6 performs a video data displays allocation designation operation in the video display format 80 through the GUI unit 704 of the network control terminal 5, and the network camera control terminal 5 performs the process of S1002. In the present embodiment, the operator 6 is assumed to have performed an operation of causing previous video data recorded in the NAS device 4a by the network camera 3a to be displayed on the large screen region 81 and causing live video data that is currently being projected by the lens units 203 of the network camera 3a to 3c and can be delivered by the video delivering unit 402 to be displayed on the small screen regions 82 to 84.

In S11009, in the network camera control terminal 5, the camera/NAS association calculating unit 708 of the network camera control terminal 5 calculates a combination of the network camera 3 connected to the NAS device 4 through the process of S1003 in order to read the video data recorded in the NAS devices 4a and 4b. Through the process of S1003, the IP address of the NAS device 4b and the mount point indicating the directory of the NAS device 4b in which the content list 501 serving as the list corresponding to the content data 502 recorded by the video recording/reading unit 408 of the network camera 3d can be referred to are designated in order to read the video recorded as the content data 502 in the video recording/reading unit 408 of the network camera 3a, the IP address of the NAS device 4a and the mount point indicating the directory of the NAS device 4a in which the content list 501 serving as the list corresponding to the content data 502 recorded by the video recording/reading unit 408 of the network camera 3b can be referred to are designated in order to read the video recorded as the content data 502 in the video recording/reading unit 408 of the network camera 3b, the IP address of the NAS device 4b and the mount point indicating the directory of the NAS device 4b in which the content list 501 serving as the list corresponding to the content data 502 recorded by the video recording/reading unit 408 of the network camera 3c can be referred to are designated in order to read the video recorded as the content data 502 in the video recording/reading unit 408 of the network camera 3c, and the IP address of the NAS device 4a and the mount point indicating the directory of the NAS device 4a in which the content list 501 serving as the list corresponding to the content data 502 recorded by the video recording/reading unit 408 of the network camera 3a can be referred to are designated in order to read the video recorded as the content data 502 in the video recording/reading unit 408 of the network camera 3d. Through the operation of S11009, the network camera 3d expected to have the highest enough capability in the simultaneous delivery performance and the simultaneous processing capability is associated with the NAS device 4a from which the video data is read, and the network cameras other than the network camera 3d are associated with the NAS devices 4 randomly with an appropriate variation.

In S11010, in the network camera control terminal 5, the NAS connection managing unit 707 of the network camera control terminal 5 notifies the NAS connection managing units 410 of the network cameras 3a to 3d of the IP address of the NAS device 4 to which the network cameras 3a to 3d are connected and the mount point indicating the directory of the NAS device in which the content list 501 serving as the list corresponding to the content data 502 recorded by the video recording/reading unit 408 of each network camera 3 can be referred to through the process of S1004 according to the correspondence relation between the network camera 3 and the NAS device 4 calculated by the process of S11009. There is no problem related to reference to video data in the video display format 80 of the operator 6 although the process of S1004 is not performed on the network camera 3 to which the video data recorded in the NAS device 4 is not actually delivered in S11010, but in the present embodiment, the process of S1004 of the network camera control terminal 5 is assumed to be performed on all the network cameras 3 in S11010.

In S11011 and S11013, in the network cameras 3a and 3c, the NAS connection managing units 410 of the network cameras 3a and 3c designate the IP address of the NAS device 4b connected in S905 and the mount point indicating the directory of the NAS device 4b in which the content list 501 serving as the list corresponding to the content data 502 recorded by the video recording/reading units 408 of the network cameras 3d and 3c can be referred to through the process of S11010, and the NAS connecting units 409 of the network cameras 3a and 3c are connected to the NAS device 4b designated in S906. The network cameras 3a and 3c to which the video data recorded in the NAS device 4b is not actually delivered by the video delivering unit 404 may not perform the process of S11011 and S11013, but since there are cases in which a next time reconnection between the network cameras 3a and 3c and the NAS device 4b is avoided, in the present embodiment, the process of S11011 and S11013 is assumed to be performed.

In S11012 and S11014, in the network cameras 3b and 3d, the NAS connection managing units 410 of the network cameras 3b and 3d designate the IP address of the NAS device 4a connected in S905 and the mount point indicating the directory of the NAS device 4a in which the content list 501 serving as the list corresponding to the content data 502 recorded by the video recording/reading units 408 of the network cameras 3b and 3a can be referred to through the process of S11010, and the NAS connecting units 409 of the network cameras 3b and 3d are connected to the NAS device 4a designated in S906. The network camera 3b to which the video data recorded in the NAS device 4a is not actually delivered by the video delivering unit 404 may not perform the process of S11012, but since there are cases in which a next time reconnection between the network camera 3b and the NAS connection 4a can be avoided, in the present embodiment, the process of S11012 is assumed to be performed.

In S11015, the NAS device 4a accepts the connection of enabling reading from the NAS device 4a by the NAS connecting units 409 of the network cameras 3b and 3d by S11012 and S11014.

In S11016, the NAS device 4b accepts the connection of enabling reading from the NAS device 4b by the NAS connecting units 409 of the network cameras 3a and 3c by S11011 and S11013.

In S11017, through the process of S1005 by the camera control unit 701, the recorder control unit 702, and the video receiving unit 703 of the network camera control terminal 5, the network camera control terminal 5 performs the setting and control for the camera control units 401 and the recorder control units 403 of the network cameras 3a to 3d, and requests to the video delivering unit 402 and the video delivering unit 404 to deliver desired video data.

In S11018 to S11021, through the process of S901 to S904 and S911 to S914 by the camera control unit 401, the recorder control unit 403, the video delivering unit 402, and the video delivering unit 404 of the network cameras 3a to 3d, the network cameras 3a to 3d perform various kinds of settings and control for the network cameras 3a to 3d, and delivers the video data requested in S11017 to the video receiving unit 703 of the network control terminal 5.

In S11022, the NAS device 4a supports reading of the content data 502 corresponding to the video data designated by the network camera 3d through the process of S914 of the video recording/reading unit 408 of the network camera 3d in S11021. In S11023, the network camera control terminal 5 causes the live video data delivered from the video delivering units 402 of the network camera 3a to 3c in S11018 to S11020 and the recorded video data of the network camera 3a delivered from the video delivering unit 404 of the network camera 3d in S11021 to be displayed on the corresponding screen regions 81 to 84 of the video display format 80 through the GUI unit 704 of the network camera control terminal 5.

As described above, as the video display format 80, the video data delivered by the video delivering unit 402 of the network camera 3a is projected onto the small screen region 82, the video data delivered by the video delivering unit 402 of the network camera 3b is projected onto the small screen region 83, the video data delivered by the video delivering unit 402 of the network camera 3c is projected onto the small screen region 84, and the recorded video data of the network camera 3a that is delivered by the video delivering unit 404 of the network camera 3d and read from the NAS device 4a is projected onto the large screen region 85, and thus the video can be referred to as desired by the operator through the monitor 36 of the network camera terminal 5.

Video Display Format Screen Allocation Change

Next, the flow of a series of processes when the operator 6 changes video data to be referred to in the large screen region 81 or the small screen regions 82 to 84 in the video display format 80 will be described. In S11024, similarly to S11008, the operator 6 performs the operation for designating video data display allocation in the video display format 80 through the GUI unit 704 of the network control terminal 5, and the network camera control terminal 5 performs the process of S1002. In the present embodiment, the operator 6 is assumed to have perform an operation of causing live video data that is currently being projected by the lens unit 203 of the network camera 3a and can be delivered by the video delivering unit 402 to be displayed on the large screen region 81, causing live video data that is currently being projected by the lens units 203 of the network cameras 3b and 3c and can be delivered by the video delivering unit 402 to be displayed on the small screen regions 82 and 83, and causing previous video data recorded in the NAS device 4a by the network camera 3a to be displayed on the small screen region 84.

In S11025, in the network camera control terminal 5, the camera/NAS association calculating unit 708 of the network camera control terminal 5 calculates a combination of the network camera 3 connected to the NAS device 4 in order to read the video data recorded in the NAS devices 4a and 4b through the process of S1003. Through the process of S1003, in order to deliver the video data to the large screen region 81, the network camera 3a releases the association with the NAS device 4b connected thereto through the process of S11010, the IP address of the NAS device 4a and the mount point indicating the directory of the NAS device 4a in which the content list 501 serving as the list corresponding to the content data 502 recorded by the video recording/reading unit 408 of the network camera 3b can be referred to are subsequently designated for the network camera 3b, the IP address of the NAS device 4b and the mount point indicating the directory of the NAS device 4b in which the content list 501 serving as the list corresponding to the content data 502 recorded by the video recording/reading unit 408 of the network camera 3c can be referred to are subsequently designated for the network camera 3c, the IP address of the NAS device 4a and the mount point indicating the directory of the NAS device 4a in which the content list 501 serving as the list corresponding to the content data 502 recorded by the video recording/reading unit 408 of the network camera 3a can be referred to are subsequently designated for the network camera 3d, and since it is considered that there is an enough capacity in the simultaneous delivery performance and the simultaneous processing capability, the IP address of the NAS device 4b and the mount point indicating the directory of the NAS device 4b in which the content list 501 serving as the list corresponding to the content data 502 recorded by the video recording/reading unit 408 of the network camera 3d can be referred to are designated. The network cameras 3b and 3c maintain the association of S11008 in order to avoid the cost for re-establishing a connection.

In S11026, in the network camera control terminal 5, the NAS connection managing unit 707 of the network camera control terminal 5 notifies the NAS connection managing units 410 of the network cameras 3a and 3d of the IP addresses of the NAS device 4b disconnected by the network camera 3a and the NAS device 4d to which the network camera 3d is newly connected and the mount point indicating the directory of the NAS device in which the content list 501 serving as the list corresponding to the content data 502 recorded by the video recording/reading unit 408 of each network camera 3 can be referred to through the process of S1004 according to the correspondence relation between the network camera 3 and the NAS device 4 calculated through the process of S11025. In S11026, in the present embodiment, the NAS connecting units 409 of the network cameras 3b and 3c do nothing because in the association with the NAS devices 4a and 4b is not changed through the process of S11025.

In S11027, in the network camera 3a, through the process of S11026, the NAS connection managing unit 410 of the network camera 3a designates the IP address of the NAS device 4b connected thereto in S905, and the NAS connecting unit 409 of the network camera 3a disconnects the designated NAS device 4b in S906.

In S11028, in the network camera 3d, through the process of S11026, the NAS connection managing unit 410 of the network camera 3d designates the IP address of the NAS device 4b connected thereto in S905, and the NAS connecting unit 409 of the network camera 3d disconnects the designated NAS device 4b in S906.

In S11029, the NAS device 4b disconnects the NAS connecting unit 409 of the network camera 3a from the NAS device 4b through S11027, and connects the NAS connecting unit 409 of the network camera 3d to the NAS device 4b through S11028.

The flow of the process of S11030 to S11036 is similar to that of S11017 to S11023.

Video Display Format Screen Allocation Change

Next, the flow of a series of processes when the operator 6 changes video data to be referred to in the large screen region 81 or the small screen regions 82 to 84 in the video display format 80 will be described. In S11037, similarly to S11008 and S11024, the operator 6 performs the operation for designating video data display allocation in the video display format 80 through the GUI unit 704 of the network control terminal 5, and the network camera control terminal 5 performs the process of S1002. In the present embodiment, the operator 6 is assumed to have perform an operation of causing live video data that is currently being projected by the lens unit 203 of the network camera 3d and can be delivered by the video delivering unit 402 to be displayed on the large screen region 81, causing live video data that is currently being projected by the lens units 203 of the network cameras 3a and 3b and can be delivered by the video delivering unit 402 to be displayed on the small screen regions 82 and 83, and causing previous video data recorded in the NAS device 4a by the network camera 3a to be displayed on the small screen region 84.

In S11038, in the network camera control terminal 5, the camera/NAS association calculating unit 708 of the network camera control terminal 5 calculates a combination of the network camera 3 connected to the NAS device 4 through the process of S1003 in order to read the video data recorded in the NAS devices 4a and 4b. Through the process of S1003, in order to read the video recorded as the content data 502 in the video recording/reading unit 408 of the network camera 3a, the IP address of the NAS device 4a and the mount point indicating the directory of the NAS device 4a in which the content list 501 serving as the list corresponding to the content data 502 recorded by the video recording/reading unit 408 of the network camera 3a can be referred to are designated, the IP address of the NAS device 4a and the mount point indicating the directory of the NAS device 4a in which the content list 501 serving as the list corresponding to the content data 502 recorded by the video recording/reading unit 408 of the network camera 3b can be referred to are subsequently designated for the network camera 3b, the IP address of the NAS device 4b and the mount point indicating the directory of the NAS device 4b in which the content list 501 serving as the list corresponding to the content data 502 recorded by the video recording/reading unit 408 of the network camera 3c can be referred to are subsequently designated for the network camera 3c, the IP address of the NAS device 4b and the mount point indicating the directory of the NAS device 4b in which the content list 501 serving as the list corresponding to the content data 502 recorded by the video recording/reading unit 408 of the network camera 3d can be referred to are designated since it is considered that there is an enough capacity in the simultaneous delivery performance and the simultaneous processing capability, and the network camera 3d releases the association with the NAS devices 4a and 4b connected thereto by the process of S11026 in order to deliver the video data to the large screen region 81.

In S11039, in the network camera control terminal 5, the NAS connection managing unit 707 of the network camera control terminal 5 notifies the NAS connection managing units 410 of the network cameras 3a and 3c of the IP addresses of the NAS device 4a and the NAS device 4b to which the network cameras 3a and 3c are connected and the mount point indicating the directory of the NAS device 4 in which the content list 501 serving as the list corresponding to the content data 502 recorded by the video recording/reading unit 408 of each network camera 3 can be referred to through the process of S1004 according to the correspondence relation between the network camera 3 and the NAS device 4 calculated through the process of S11038. In S11039, in the present embodiment, the NAS connecting unit 409 of the network camera 3b does nothing because in the association with the NAS device 4a is not changed through the process of S11039.

In S11040, in the network camera 3a, through the process of S11039, the NAS connection managing unit 410 of the network camera 3a designates the IP address of the NAS device 4a connected thereto in S905, and the NAS connecting unit 409 of the network camera 4a establishes a connection with the designated NAS device 4b in S906.

In S11041, in the network camera 3c, through the process of S11039, the NAS connection managing unit 410 of the network camera 3c is newly connected to the mount point indicating the directory of the NAS device 4b in which the content list 501 serving as the list corresponding to the content data 502 recorded by the video recording/reading unit 408 of the network camera 3d in the NAS device 4b already connected in S11013 in S905, and the video data recorded in the NAS device 4b by the network camera 3d is enabled to be referred to by the video managing unit 405 of the network camera 3c.

In S11042, in the network camera 3d, through the process of S11039, the NAS connection managing unit 410 of the network camera 3d designates the addresses of the NAS devices 4a and 4b connected thereto in S905, and the NAS connecting unit 409 of the network camera 3d disconnects the designated. NAS devices 4a and 4b in S906.

In S11043, the NAS device 4a accepts the connection from the NAS connecting unit 409 of the network camera 3a through the process of S11040 that enables reading from the NAS device 4a, and disconnects the NAS connecting unit 409 of the network camera 3d from the NAS device 4a through S11042.

In S11044, the NAS device 4b accepts the connection from the NAS connection managing unit 410 of the network camera 3c through the process of S11041 that enables reference of the NAS device 4b to the content list and content data reading, and disconnects the NAS connecting unit 409 of the network camera 3d from the NAS device 4b through S11042.

The flow of the process of S11045 to S11051 is similar to that of S11017 to S11023 and S11030 to S11036.

As described above, when the operator 6 changes the video data to be referred to in the screen regions 81 to 84 in the video display format 80, a connection configuration between the network camera 3 and the NAS device 4 in the video recording/delivering system 1 can be dynamically changed without awareness by the operator 6, and it is possible to refer to desired video data.

The flow of the process of implementing the recording/delivery function provided by the video recording/delivering system using the NAS device 4 by comparing the setting state of the network camera 3 connected to the video recording/delivering system 1 at each point in time with the specification of the network camera 3 and dynamically changing the connection configuration of each device in the video recording/delivering system 1 has been described above. As a result, even when some devices configuring the video recording/delivering system 1 are replaced with a common IT device, it is possible to implement the function and the performance of the video recording/delivering system 1 without interference with reference to a plurality of pieces of video data by the operator 6.

As a result, all the devices configuring the video recording/delivering system need not have the dedicated protocol specific to the video recording/delivering system, and thus when some devices configuring the video recording/delivering system are replaced with a general-purpose IT device such as a NAS device, it is unnecessary to develop, for example, the recorder terminal having the dedicated protocol specific to the video recording/delivering system, the development cost of the video recording/delivering system is reduced, and thus the video recording/delivering system can be provided at a lower cost than in the related art.

(Modified Example)

The camera specification unit 706 of the network camera control terminal 5 of the present embodiment statically detects the performance and the capability of the network camera 3 in terms of the specification but may dynamically detect whether or not the network camera has an enough capacity in the performance and the capability. In this case, the camera specification unit 706 of the network camera control terminal 5 may be configured to detect whether or not the network camera has an enough capacity in the performance and the capability such that the camera control unit 701 or the recorder control unit 702 of the network camera control terminal 5 causes the camera control unit 401 or the recorder control unit 403 of the network camera 3 to check whether or not each network camera 3 connected to the video recording/delivering system 1 has an enough capacity in the performance and the capability. A similar function can be implemented by executing this process instead of S1003 in the network camera control terminal process 1000 of the present embodiment.

The content list 501 of the present embodiment is distributedly recorded in the respective NAS devices 4, but the content list 501 distributedly recorded in the respective NAS devices 4 may collected in a server device (not illustrated) connected to the video recording/delivering system 1 or the network camera control terminal 5 for each content list 501 of each NAS device 4, and when desired content is delivered, the network camera control terminal 5 may detect the network camera 3 associated with the NAS device storing the content by making an inquiry to the NAS connection managing unit 707 of the network camera control terminal 5 with reference to the content list 501 and request the video delivering unit 404 of the network camera 3 to deliver the content. In this case, a correspondence relation between the content list 501 and the NAS device 4 associated with the content list 501 is managed. In the case of the present configuration, the video managing unit 405 of the network camera 3 is unnecessary.

The network camera 3 of the present embodiment is configured such that each of the network cameras 3 includes the camera protocol unit 40, the recorder protocol unit 41, and the NAS collaborating unit 42, but among a plurality of network cameras 3 connected to the video recording/delivering system 1, some network cameras 3 may be configured to include any one of the camera protocol unit 40, the recorder protocol unit 41, and the NAS collaborating unit 42, and the same function as the video recording/delivering system 1 can be implemented.

Any one of the camera protocol unit 40, the recorder protocol unit 41, and the NAS collaborating unit 42 arranged in the network camera 3 of the present embodiment may be arranged in the NAS device 4 or the network camera control terminal 5 connected to the video recording/delivering system 1, and the same function as the video recording/delivering system 1 can be implemented.

Further, in the video recording/delivering system 1, when a plurality of network cameras control terminals 5 are connected, the camera/NAS association calculating unit 708 of the network camera control terminal 5 may be shared or may be an independent configuration as a server device (not illustrated) connected to the video recording/delivering system 1, and the same function as the video recording/delivering system 1 can be implemented.

### REFERENCE SIGNS LIST

1 video recording/delivering system
2 data communication network
3a, 3b, 3c, and 3d network camera
4a, 4b NAS device
5 network camera control terminal
6 operator
200, 30 CPU
201, 32 ROM
31, 202 RAM
203 lens unit
204 image sensor unit
205 video processing unit
206, 33 network interface
207, 35 secondary storage unit
208 video interface
34 graphic control unit
36 monitor

1. A network camera that is connected with a data recording device and a network camera control terminal via a network, including:
a storage unit; and
an operation processing unit,
wherein the operation processing unit receives a delivery request for video data transmitted from the network camera control terminal using a first protocol via the network using the first protocol, and
the operation processing unit delivers live video data that is being currently projected and temporarily recorded in the storage unit or video data that is acquired from the data recording device using a second protocol and temporarily recorded in the storage unit to the network camera control terminal via the network using the first protocol in response to the delivery request for the video data.

2. The network camera according to claim 1,
wherein the second protocol is a general-purpose protocol, and the data recording device is a storage device.

3. A network camera control terminal that is connected with a data recording device and a plurality of network cameras via a network, including:
an input unit;
a storage unit;
an operation processing unit; and
a display unit,
wherein the operation processing unit allocates video data to be displayed on each of a plurality of screen regions of the display unit based on operation information received through the input unit,
the operation processing unit decides a network camera that delivers the video data to the network camera control terminal for each allocated video data based on specification information of each of the network cameras stored in the storage unit and a setting state or an operation state of each of the network cameras,
the operation processing unit transmits a delivery request for the video data to each of the decided network cameras via the network, and
the operation processing unit receives the video data requested by the delivery request from each of the decided network cameras via the network, and causes the received video data to be displayed on the screen region.

4. The network camera control terminal according to claim 3,
wherein the video data is video data recorded in the data recording device or live video data being currently projected by the network camera.

5. The network camera control terminal according to claim 4,
wherein the data recording device is a storage device that supports a general-purpose protocol.

6. The network camera control terminal according to claim 5,
wherein the screen regions include a large screen region on which video data delivered at a high resolution and a high frame rate is displayed and a small screen region on which video data delivered at a low resolution and a low frame rate is displayed.

7. A video recording/delivering system, including:
a plurality of network cameras that are connected to a network;
a data recording device; and
a network camera control terminal,
wherein each of the network cameras receives a delivery request for video data transmitted from the network camera control terminal using a first protocol via the network using the first protocol,
each of the network cameras delivers live video data that is being currently projected and temporarily recorded in a storage unit or video data that is acquired from the data recording device using a second protocol and temporarily recorded in the storage unit to the network camera control terminal via the network using the first protocol in response to the delivery request for the video data,
the network camera control terminal transmits a delivery request for the video data to each of the network cameras via the network using the first protocol, and
the network camera control terminal receives the video data requested by the delivery request using the first protocol from each of the network cameras via the network using the first protocol, and causes the received video data to be displayed on a display unit.

8. The video recording/delivering system according to claim 7,
wherein the second protocol is a general-purpose protocol, and the data recording device is a storage device.

9. The video recording/delivering system according to claim 8,
wherein the network camera control terminal allocates video data to be displayed on each of a plurality of screen regions of the display unit based on operation information received through an input unit,
the network camera control terminal decides a network camera that delivers the video data to the network camera control terminal for each allocated video data based on predetermined specification information of each of the network cameras and a setting state or an operation state of each of the network cameras,
the network camera control terminal transmits a delivery request for the video data to each of the decided network cameras via the network using the first protocol, and
the network camera control terminal receives the video data requested by the delivery request from each of the decided network cameras via the network using the first protocol, and causes the received video data to be displayed on the screen region.

10. The video recording/delivering system according to claim 9,
wherein the screen regions include a large screen region on which video data delivered at a high resolution and a high frame rate is displayed and a small screen region on which video data delivered at a low resolution and a low frame rate is displayed.
